(19) United States
(12) Patent Application Publication
(10) Pub. No.: US 2012/0247571 A1
(43) Pub. Date: Oct. 4, 2012

(54) JET ENGINE NACELLE REAR ASSEMBLY

(75) Inventors: Guy Bernard Vauchel, Harfleur (FR); Pierre Caruel, Le Havre (FR); Jean-Philippe Joret, Beuzeville (FR)

(73) Assignee: AIRCELLE, Gonfreville L'Orcher (FR)

(21) Appl. No.: 13/514,554

(22) PCT Filed: Nov. 26, 2010
(86) PCT No.: PCT/FR10/52546

§ 371 Date: Jun. 7, 2012

(30) Foreign Application Priority Data
Dec. 7, 2009 (FR) 09/05903

(51) Int. Cl. F02B 77/00

(52) U.S. Cl. 137/15.1

(57) ABSTRACT

The present invention relates to a nacelle rear assembly (1) including a pod-shaped internal structure (11), said internal structure comprising at least one downstream portion (15) and one upstream portion (13) that are each movably mounted between an operative position, in which said portions are connected, and at least one maintenance position, in which said portions are separate from each other, the downstream portion being movably mounted by means of sliding while the upstream portion is movable by opening at least one door. The downstream portion and upstream portion are provided with a connection means that is capable of engaging therebetween. Said assembly is characterized in that at least one of the downstream and upstream portions is provided with a hinging means (131, 151) having a range of movement in at least one direction so as to enable stress-free control and operation of the portion in question.

### TECHNICAL FIELD

The present invention relates to a jet engine nacelle for a reaction motor, and a nacelle equipped with one such assembly.

### BRIEF DISCUSSION OF RELATED ART

An airplane is moved by one or more turbojet engines each housed in a nacelle.

A nacelle generally has a tubular structure comprising an air intake upstream of the turbojet engine, an intermediate assembly intended to surround a fan of the turbojet engine, a rear assembly capable of incorporating thrust reverser means and intended to surround the combustion chamber and all or some of the compressor and turbine stages of the turbojet engine, and generally ends with a jet nozzle whereof the outlet is situated downstream of the turbojet engine.

Modern nacelles are intended to house a dual flow turbojet engine capable of creating, on the one hand, a hot air flow (also called primary flow) coming from the combustion chamber of the turbojet engine, and on the other hand, a cold air flow (secondary flow) coming from the fan and circulating outside the turbojet engine through an annular passage, also called tunnel, formed between an inner structure defining a fairing of the turbojet engine and an inner wall of the nacelle. The two flows of air are discharged from the turbojet engine through the back of the nacelle.

The thrust reverser means make it possible, during landing of an airplane, to improve the braking capacity thereof by reorienting at least part of the thrust created by the turbojet engine forward. In this phase, the reverser generally covers the cold flow tunnel and orients the latter toward the front of the nacelle, thereby creating a counterthrust that is added to the braking of the wheels of the airplane.

The means implemented to perform this reorientation of the cold flow vary depending on the type of reverser.

Known from the prior art is a jet engine nacelle rear assembly, comprising:

a cowl,

a pod-shaped inner structure whereof at least the downstream portion is of the O-duct type and is axially slidingly movable between an operative position in which it covers the gas generator of said turbojet engine and defines a cold air annular tunnel with said cowl, and a maintenance position situated downstream of said operative position.

The expression “pod-shaped” means that the inner structure has a central zone with a larger diameter than its upstream and downstream ends.

The expression “O-duct,” commonly used in the airplane nacelle field, means that the concerned member (in this case, the downstream portion of the inner structure) extends over practically the entire circumference of the gas generator of the airplane.

This expression is used as opposed to “D-duct,” which designates a member that only extends over half the circumference of the gas generator (in this case, the term “half-shell” member is also used).

By definition, an O-duct member only allows access to the gas generator by axial sliding.

In practice, due to the curved shape of the gas generator, an O-duct inner structure risks abutting thereon when it slides from its operative position to its maintenance position: the downstream movement of the inner structure is therefore limited, so that it is only possible to access certain members of the gas generator by providing access hatches on that member.

In order to offset this drawback, it has been provided to separate the inner structure into two parts, i.e. a sliding downstream part and an articulated opening upstream part. Such a structure is described in application FR 2 916 426, for example.

Despite its advantages, such an embodiment still has some limitations.

First, the structure of the downstream engine cowl depends on the external mobile cowl of the nacelle, and in particular in the case of a nacelle equipped with a thrust reverser device. In fact, the outer cowl being attached to the inner cowl by thrust reverser blocking flap driving rods, their respective kinematics are closely related.

The interaction between the support structure of the engine cowls and the position of the cowls on the engine, due to the differential movements of the pylon with the engine, means that the interfacing guide structure has a high risk of producing parasitic changes in the structures due to the hyperstatism generated by that device.

The locking in the lower part of the turbojet engine cowls requires having complex cutouts and catching interfaces.

### BRIEF SUMMARY

The present invention aims in particular to provide a jet engine nacelle rear assembly of the aforementioned type making it possible to offset these drawbacks, and in particular to obtain an isostatic assembly, while preserving easy access to the turbojet engine during maintenance operations.

To that end, the present invention relates to a turbojet engine nacelle rear assembly, comprising, on the one hand, an outer cowl, and on the other hand, a pod-shaped internal structure, said internal structure comprising at least one downstream portion and one upstream portion that are each movably mounted between an operative position, in which said portions are connected, thereby covering the gas generator of said turbojet engine and defining an annular cold air tunnel with said outer cowl, and at least one maintenance position, in which said portions are separate from each other so as to allow access to the gas generator, the downstream portion being movably mounted by means of axial sliding while the upstream portion is movable by outwardly opening at least one door, the downstream portion and upstream portion being provided with a connection means capable of engaging therebetween, said assembly being characterized in that at least one of the downstream and upstream portions is provided with a hinging means having a range of movement in at least one direction so as to enable stress-free control and operation of the portion in question.

Thus, owing to an assembly according to the invention, the assembly does away with risks of hyperstatism.

Advantageously, the upstream portion and the downstream portion can be moved into their maintenance position independently of one another.

Also advantageously, each of the upstream and downstream portions is equipped with hinging means with a range of motion in at least one direction so as to enable stress-free control and operation of each concerned portion.

Preferably, the downstream portion and the upstream portion are equipped with connecting means capable of cooperating with one another, said assembly being characterized in that the connecting means are of the blade/groove type comprising at least one at least partially peripheral ring forming a blade and capable of cooperating with a corresponding groove of the other portion.

The upstream portion is also equipped with connecting means capable of cooperating with corresponding connecting means of a case of the turbojet engine. These connecting means will traditionally be of the blade/groove type.

Preferably, the upstream portion comprises at least one locking means of the door.

Advantageously, the bolt is positioned substantially in a same plane as the hinges of the upstream portion.

Preferably, the upstream portion comprises hinges preferably positioned in the upper portion, i.e. close to an interface with an attachment mast.

Also preferably, the upstream portion is equipped with at least one hinge on either side of the pylon, the two hinges being connected by a through rod.

Advantageously, the connecting rod does not come into contact with surrounding structures when the upstream portion is in the operative position.

Alternatively or complementarily, the downstream portion is associated with at least one guide means mounted with a vertical range of motion, in particular upstream of said downstream portion.

Advantageously, the downstream portion is associated with at least one guide means mounted with a rotational range of motion, in particular downstream of said downstream portion.

The rotational range of motion may in particular be done in a substantially longitudinal plane and/or in a transverse plane.

Also advantageously, the downstream portion is associated with at least one guide means having an incline angle relative to a substantially longitudinal axis of the assembly.

Preferably, the guide and hinging means of at least one of the downstream and upstream portions have an operative configuration in which they have a minimum play and a maintenance configuration in which they have a wider play.

Advantageously, the guide assembly allows a range of motion upstream of the downstream portion.

Also preferably, the guide and hinging means of at least one of the downstream and upstream portions are equipped with centering means, in particular pins.

Advantageously, the upstream portion and the downstream portion are equipped with at least one correct-positioning means, in particular in the form of a heel-piece.

Advantageously, a visual indication that the downstream cowl is not locked by the upstream cowl is placed in a zone visible by the maintenance staff.

The present invention also relates to an airplane nacelle, characterized in that it is equipped with an assembly according to any one of the preceding claims.

### BRIEF DESCRIPTION OF THE DRAWINGS

The present invention will be better understood in light of the following detailed description, in reference to the appended drawings, in which:

FIG. 1 is a diagrammatic illustration of a rear assembly according to the invention.

FIG. 2 is a diagrammatic longitudinal cross-sectional view of the assembly of FIG. 1.

FIG. 3 is an enlarged partial view of the junction between the upstream portion of the assembly of FIG. 2 and a fan.

FIG. 4 is an enlarged partial view of the junction between the upstream portion of the assembly of FIG. 2 and the downstream portion of the same assembly.

FIG. 5 is an enlarged partial view in transverse cross-section taken at a hinge of the upstream portion of the assembly of FIG. 1.

FIG. 6 is a diagrammatic illustration of a guide means for the rear portion of the assembly of FIG. 1.

FIG. 7 is a diagrammatic illustration of a correct-positioning means in the form of a heel-piece.

FIG. 8 is a diagrammatic illustration of centering means equipping the heel-piece of FIG. 7.

### DETAILED DESCRIPTION

FIGS. 1 to 4 show various views of a rear assembly 1 for a turbojet engine 2, in particular comprising a gas generator 3 and, upstream thereof, a fan, whereof a case 5 is visible.

A front frame 7, secured downstream of the fan case 5, makes it possible to connect the engine 1 to a pylon 9 intended to be fastened under an airplane wing.

In this particular configuration, the front frame 7 is said to be structural, i.e. it makes it possible to bear the weight of the turbojet engine 1 assembly, as well as the thrust and counterthrust forces created by said turbojet engine.

It must be understood that the present invention is in no way limited to the presence of such a structural front frame, and that any traditional means for fastening the turbojet engine 1 to the pylon 9 are also within the scope of the present invention.

An internal nacelle structure 11, comprising an upstream portion 13 and a downstream portion 15, forms a fairing for the gas generator 3 and is connected to the pylon 9 by means allowing appropriate kinematics, which will be described later.

The inner structure 11 defines, with an outer cowl (not shown), an annular cold air tunnel, capable of allowing the circulation of cold air created by the fan in the downstream direction of the nacelle.

Depending on the type of nacelle, the outer cowl may comprise thrust reverser means, typically comprising a plurality of flaps capable of being actuated by connecting rods during the sliding of the outer cowl relative to the inner structure 11. The operation of a thrust reverser is not the subject-matter of the present application, and is perfectly known by those skilled in the art.

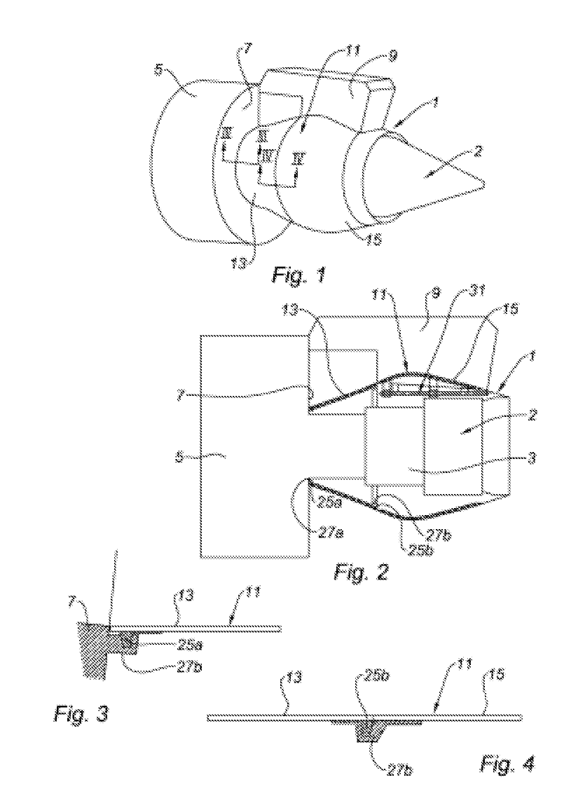

Traditionally, the inner structure 11 is connected to the fan case 5 via the upstream portion 13 by means of a blade 25a/groove 27b connection (FIGS. 2 and 3) respectively belonging to the upstream portion 13 and the case 5. Of course, the opposite arrangement or other known connecting means are also possible.

As shown in particular in FIGS. 2 and 4, the adjoining edges of the upstream portion 13 and the downstream portion 15 of the inner structure 11 comprise complementary connecting means of the groove 27b and blade 25b type.

These connections may be completed by at least one O-ring (not shown).

These connecting means 25, 27 axially block the upstream 13 and downstream 15 portions, relative to one another and relative to the fan case 5.

The downstream portion 15 is slidingly mounted on the pylon 9 owing to rail and guideway means shown symbolically by reference 31, visible in FIG. 2.

This upstream portion 13 in fact comprises two half-doors capable of opening outwardly, i.e. moving away from the gas generator 3, by pivoting around respective axes positioned substantially parallel to the rail and guideway means 31, or in the upper portion of the upstream structure integrating part of the lateral surface of the pylon (island) or at the island and tail interface.

In the operative position, the two doors are closed and locked using locking means that will preferably be positioned in the lower portion (i.e. opposite the pylon 9) and preferably placed in the same plane as hinges 131 of the doors. The locking also aims to ensure prestressing of the doors around locking straps so as to allow optimal structural strength.

This particular structure of the upstream portion 13 differs from that of the downstream portion 15, the latter being of the “O-DUCT” type as defined in the preamble of the description, i.e. extending over practically the entire circumference of the gas generator 3.

In general, the control of the upstream 13 and downstream 15 portions is done as follows:

the two doors of the upstream portion 13 of the inner structure 11 are first opened outwardly.

To keep these doors in the open position, a maintenance rod may be inserted extending between the two lower edges of said doors.

The opening of the two doors makes it possible to remove the blades 27b of said two doors from the complementary groove 25b formed in the downstream portion 15 of the inner structure 11.

From there, it is possible to slide the downstream portion 15 downstream of the gas generator 3, the two doors remaining in the open position.

In this maintenance configuration, it is therefore possible to access the downstream zone of the gas generator 3 easily, as well as a large part of its upstream zone.

According to the invention, the hinge means of at least one of the downstream 15 and upstream 13 portions have a range of motion in at least one direction so as to enable stress-free control and operation of the concerned portion

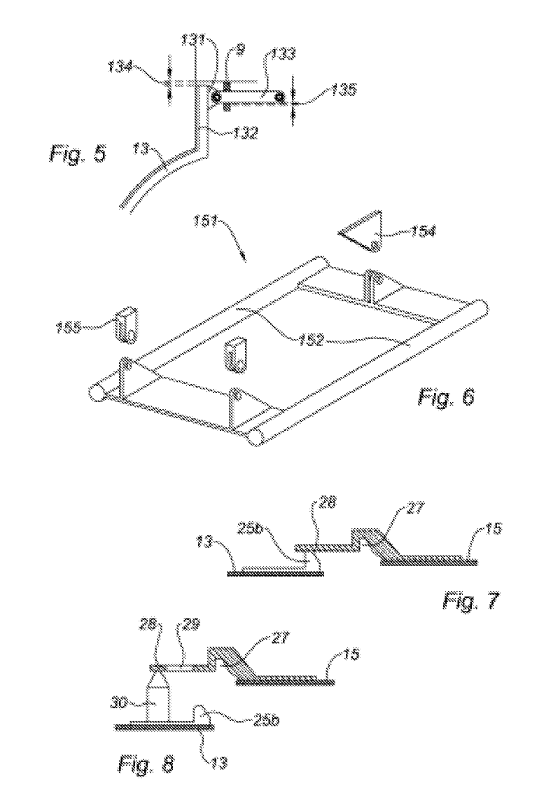

FIGS. 5 and 6 illustrate examples of embodiments of these hinging means, respectively for the upstream portion 13 and the downstream portion 15.

FIG. 5 shows an example of the hinging of a door of the upstream portion 13 by a hinge 131.

According to one preferred embodiment, the hinges 131 are situated near the pylon 9.

In this case, the illustrated example shows an upstream portion 13 at an interface island 132 with the pylon 9. This interface island 132 is an extension of an upstream portion panel aiming to extend the pylon 9 to the cylindrical portion, also called tail, and to ensure the aerodynamic continuity. Of course, in the locations where the pylon is long enough, the upstream portion 13 will not have an island and will only comprise the tail.

It will be noted that the hinge line is not necessarily parallel to a substantially longitudinal axis of the nacelle.

According to the invention, the hinges 131 must provide a stress-free hinging.

In fact, the machining allowances associated with the expansion differences of the components and movements, as well as the reduced distance between a first hinge point and the attachment of the upstream cowl 13 of the inner structure 11 on the fan case 5, make it necessary to have specific control kinematics.

In the case at hand, the example of FIG. 5 shows an arrangement that makes it possible to re-center and maintain the structure 11 relative to the pylon 9 by installing a connecting rod 133 passing through said pylon 9 to connect two hinges 131 on either side thereof.

Play 134 is also formed between the upstream cowl 13 and the pylon 9. This play 134 is, however, minimized in order to guarantee optimal aerodynamic performance. A sealing device (not shown) will make it possible to isolate the inner portion of the cowl 13 from the flow of the secondary flow. Play 135 is also formed between the connecting rod and the connecting rod passage in the pylon 9.

In the closed position of the upstream portion 13, the hinging assembly and the connecting rod 133 are there for free, without axial or vertical contact with the pylon 9. When the upstream portion 13 is open, the connecting rod passage 133 serves as connecting rod support 133.

Likewise, the downstream portion 15 is hinged so as to allow stress-free operation.

The downstream portion 15 is centered and positioned by a strap formed with the upstream portion 13. The machining allowances associated with the expansion differences of the components and movements, as well as the reduced distance between a first fastening point of the guideway on the pylon 9 and the attachment of the downstream portion 15 of the inner structure 11 on the upstream portion 13, make it necessary to have a specific composition of the sliding system.

To that end, according to the invention and as shown in FIG. 6, the system 151 of guideways 152 enables a stress-free guiding of the downstream cowl.

The example illustrated in FIG. 6 makes it possible not to cause stress in the structures during use.

To that end, the axial position is given by a crosshead of the downstream portion 15 of the corresponding guideway 152 of the guiding system 15, while the vertical position is given by centering the strap interface supported by the upstream portion 13 at the junction thereof with the downstream portion 15. The guide assembly 151, at the upstream end thereof, is freely mounted on at least one support incorporated into a fixed structure of the airplane such as the pylon 9.

More specifically, the guide assembly 151 will be fastened upstream to the pylon 9 using upstream supports 155 forming eyelets and having an oblong opening allowing a vertical range of motion of the guideway support 151.

Downstream, the guide assembly 151 is advantageously connected by a central point 154 to the fixed structure of the airplane (pylon 9). This point allows a free range of motion around its pivot point. By using a ball joint, an additional degree of motion is allowed in a vertical transverse plane.

The example of FIG. 6 shows yokes 155, 154 supported by the pylon.

Of course, the arrangement can be reversed and the yokes 154, 155 can be supported by the guide assembly 151.

It will also be noted that alternatives to a rail/guideway system can be used. It is also possible to have sliding or rolling contacts.

Connecting arms between the two guideways can be added in particular relative to the crosshead structure supported by the downstream engine cowl so as to react all of the forces opening the structure.

The guide system 151 may also have a non-parallel configuration with the longitudinal axis of the nacelle and have an angle therewith. The support 151 may remain non-parallel when the upstream portion 13 is open, or find itself in a substantially parallel position when the upstream portion 13 is open. This makes it possible to further limit the stresses that may be exerted during sliding of the downstream portion 15.

Advantageously, it is also possible to provide several configurations for the guide system. More specifically, in the active position, the guide system must generally comprise a minimal play, called functional play, between the rail and the guideway, while in the open position, more significant play will make placement and sliding easier.

In order to allow easy placement and disassembly of the inner structure 11, one will in particular provide:

a trimming definition of the upstream portion 13 such that it is not necessary to disassemble the inner structure 11 in several parts to install it on the guide assembly 151 due to interference with the members of the turbojet engine 2. It is possible for this trimming not to be in a same plane;

the guide assembly 151 must preferably make it possible to advance the inner structure 11 to offer access to the disassembly of a primary shroud if necessary and to ensure the release of components supported by said inner structure 11 that would interfere with the primary shroud;

the guide assembly 151 may be equipped with removable downstream end-of-travel stops.

Complementarily, it is advantageous to provide a system ensuring reclosing between the upstream portion 13 and the downstream portion 15.

Thus, to avoid reclosing of the upstream portion 13 without taking the downstream portion 15 into account, and in particular incomplete closing, it is advantageous to provide a correct-positioning element. In FIG. 7, one such correct-positioning element is shown in the form of a heel-piece 28.

In the illustrated example, at least one heel-piece 28 is supported by the slotted ring forming the groove 27. The length of the heel-piece 28 depends on the considered distance between the two parts 13, 15 of the inner structure 11 as detectable by sight and for which a correct-positioning element is no longer necessary.

The heel-piece 28 could be continuous, or discrete, local or multiple.

It is also possible to provide means for centering the upstream 13 and downstream 15 portions relative to one another. One example embodiment is illustrated in FIG. 8 in the form of a positioning pin 30 capable of cooperating with a corresponding bore 29 formed in the correct-positioning heel-piece 28.

The invention may also advantageously be completed by means, in particular mechanical means, for visually indicating closing and locking.

Although the invention has been described with one particular embodiment, it is of course in no way limited thereto and encompasses all equivalent techniques of the described means as well as combinations thereof if they are within the scope of the invention.

1. A turbojet engine nacelle rear assembly, comprising, on the one hand, an outer cowl, and on the other hand, a pod-shaped internal structure, said internal structure comprising at least one downstream portion and one upstream portion that are each movably mounted between an operative position, in which said portions are connected, thereby covering the gas generator of said turbojet engine and defining an annular cold air tunnel with said outer cowl, and at least one maintenance position, in which said portions are separate from each other so as to allow access to the gas generator, the downstream portion being movably mounted by means of axial sliding while the upstream portion is movable by outwardly opening at least one door, the downstream portion and upstream portion being provided with a connection means capable of engaging therebetween, said assembly being wherein at least one of the downstream and upstream portions is provided with a hinging means having a range of movement in at least one direction so as to enable stress-free control and operation of the portion in question.

2. The rear assembly according to claim 1, wherein the upstream portion and the downstream portion can be moved into their maintenance position independently of one another.

3. The assembly according to claim 1, wherein each of the upstream and downstream portions is equipped with hinging means with a range of motion in at least one direction so as to enable stress-free control and operation of each concerned portion.

4. The assembly according to claim 1, wherein the downstream portion and the upstream portion are equipped with connecting means capable of cooperating with one another, said assembly being wherein the connecting means are of the blade/groove type comprising at least one at least partially peripheral ring forming a blade and capable of cooperating with a corresponding groove of the other portion.

5. The rear assembly according to claim 1, wherein the upstream portion comprises at least one locking means of the door.

6. The rear assembly according to claim 5, wherein the bolt is positioned substantially in a same plane as the hinges of the upstream portion.

7. The assembly according to claim 1, wherein the upstream portion comprises hinges preferably positioned in the upper portion, i.e. close to an interface with an attachment mast.

8. The assembly according to claim 7, wherein the upstream portion is equipped with at least one hinge on either side of the pylon, the two hinges being connected by a through rod.

9. The assembly according to claim 8, wherein the connecting rod does not come into contact with surrounding structures when the upstream portion is in the operative position.

10. The assembly according to claim 1, wherein the downstream portion is associated with at least one guide means mounted with a vertical range of motion, in particular upstream of said downstream portion.

11. The assembly according to any claim 1, wherein the downstream portion is associated with at least one guide means mounted with a rotational range of motion, in particular downstream of said downstream portion.

12. The assembly according to claim 1, wherein the downstream portion is associated with at least one guide means having an incline angle relative to a substantially longitudinal axis of the assembly.

13. The assembly according to claim 1, wherein the guide and hinging means of at least one of the downstream and upstream portions have an operative configuration in which they have a minimum play and a maintenance configuration in which they have a wider play.

14. The assembly according to claim 1, wherein the guide and hinging means of at least one of the downstream and upstream portions are equipped with centering means, in particular pins.

15. The assembly according to claim 1, wherein the upstream portion and the downstream portion are equipped with at least one correct-positioning means, in particular in the form of a heel-piece.

16. An airplane nacelle, comprising an assembly according to claim 1.
